(19) United States
(12) Patent Application Publication
(10) Pub. No.: US 2007/0153121 A1
(43) Pub. Date: Jul. 5, 2007

(54) VIDEO DATA ACQUISITION SYSTEM

(76) Inventor: Juan Pertierra, West Lafayette, IN (US)

Correspondence Address: BAKER & DANIELS LLP, 300 NORTH MERIDIAN STREET, SUITE 2700, INDIANAPOLIS, IN, 46204, US

(21) Appl. No.: 11/561,804

(22) Filed: Nov. 20, 2006

Related U.S. Application Data
(60) Provisional application No. 60/737,988, filed on Nov. 18, 2005.

(51) Int. Cl. H04N 5/225

(52) U.S. Cl. 348/375

(57) ABSTRACT

The present invention relates to a hardware and software system for filmmakers and videographers interested in recording the current maximum quality of digital video. The system includes extracting uncompressed image data from a digital camera, transmitting the data over an interface to any type of recording and/or monitoring device for rendering.

### BACKGROUND OF THE INVENTION

1. Field of the Invention.

The invention relates to a hardware and software system for filmmakers and videographers interested in recording the current maximum quality of digital video.

2. Description of the Related Art.

In 1982, Sony released the first professional camcorder named “Betacam. ” Betacam was developed as a standard for professional camcorders. In 1983, Sony released “Betamovie” for consumers, the first domestic camcorder. The unit was bulky by today's standards, and since it could not be held in one hand, was typically used by resting on a shoulder. Within a few years, manufacturers introduced two new tape formats tailored to the application of portable-video: the VHS-C format and the competing 8 mm. VHS-C was essentially VHS with a reduced-size cassette. The 8 mm video radically reduced the size of camcorders and generally produced higher quality recordings than a VHS/NVHS-C camcorder.

In the late 1990's, the camcorder reached the digital era with the introduction of miniDV. Its cassette media was even smaller than 8 mm, allowing another size reduction of the tape transport assembly. The digital nature of miniDV also improved audio and video quality over the best of the analog consumer camcorders. The evolution of the camcorder has seen the growth of the camcorder market as price reductions and size reductions make the technology more accessible to a wider audience.

Today, most professional digital video cameras have three imaging sensors, each sensor records one basic color: Red, Green or Blue. Each imaging sensor also has a certain number of sensor elements each representing a pixel in the resulting image. Many cameras implement a technique commonly called “Pixel Shift,” in which the three sensors are not aligned on the image plane, but rather one or more sensors are shifted at sub-pixel offsets. This means that if two of the sensors are shifted relative to each other, then they record different optical details coming from the lens.

### SUMMARY OF THE INVENTION

The Video Data Acquisition system is comprised of both hardware and software counterparts. The hardware comprises an electronic circuit board that is installed inside a host digital video camera. During operation, this board is interfaced to the software. The hardware system is installed into a pre-existing professional digital video camera allowing a camera to produce higher levels of digital quality. The Video Data Acquisition system also comprises software that controls recording and video file rendering. The software may be part of a computer's operating system (OS) or separate from the OS, such as in a portable custom hard disk array. As the video data is recorded by the Video Data Acquisition system, a raw video data file is stored and rendered by the software.

Throughout the application when describing the systems and methods of the present invention, the software will be discussed as if it resides on a computer's operating system. This is used for illustrative purposes only in order to simply the discussions and it is not intended that the systems and methods of the present invention be limited by this example.

During operation, the electronic circuit board is interfaced to the operating system by any number of methods well known to the art, including but not limited to a USB connection. An exemplary electronic circuit board that may be installed in such cameras has the following main components: an FPGA, SDRAM, and a USB3250 USB 2.0 Physical Layer. The FPGA may be programmed using a combination of the standard hardware design techniques and methods. For example, the Xilinx ISE WebPack software may then be used for all stages of installing and programming the Video Data Acquisition system.

The FPGA of this embodiment may be programmed with a USB 2.0 Core which allows it to interface with the USB3250, which in turn interfaces the entire board to the USB Bus. The FPGA may also be programmed to interact with the SDRAM Memory, allowing it to store and retrieve data from the SDRAM chip. Finally, the digitized signals from the camera's internal Analog-To-Digital converters are fed directly to the FPGA. These signals contain the unaltered digital video initially captured by the camera of this embodiment.

The Video Data Acquisition system records all the information originally recorded by the camera's image sensors. There is a large amount of data that comes from the image sensors, so video cameras typically reduce the amount of information by several methods such as compression and decimation, among others. Even though these methods are efficient in greatly reducing the amount of information, they have detrimental effects on the quality of the images. If image quality is of importance, it is very desirable to obtain all the information that the imaging sensors capture, in its unaltered form. The Video Data Acquisition System is able to extract this information and interpret it in several ways that expand the capabilities of the digital video camera.

Most professional digital video cameras have three imaging sensors. Each sensor records one basic color: Red, Green or Blue. Each imaging sensor also has a certain number of sensor elements representing a pixel in the resulting image. The Video Data Acquisition system is capable of reproducing an image with the same number of pixels as the sensor. For example, if a three sensor camera has sensors with 640 elements across and 480 elements high, then the system is capable of extracting a full color RGB image that is 640×480 pixels in size.

However, many cameras implement a technique commonly called “Pixel Shift”, in which the three sensors are not aligned on the image plane, but rather one or more sensors are shifted at sub-pixel offsets. This means that if two of the sensors are shifted relative to each other, then they record different optical details coming from the lens. Up to now, all the cameras implementing this technique did not exploit it for gaining a larger output image. They all output video with a frame size equal or less pixels than elements in each sensor. The disclosed software, however, is able to exploit the additional detail captured by taking into consideration the “Pixel Shift” when the files are processed, generating a higher resolution image.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a systematic block diagram depicting the location where the Video Data Acquisition (labeled Andromedia) may be installed in a standard video recording camera.

FIG. 2 is a flowchart diagram depicting the digital video processing steps of an exemplary system.

FIG. 3 depicts lengths of magnet wire surface mounted to FPGA pads.

FIG. 4 depicts a crimp style female receptacle housing.

FIG. 5 depicts the bottom of an FPGA/AUSB board showing wires surface mounted to USB pads at right end of board.

FIG. 6 depicts a close-up view of the board mount header assembly.

FIG. 7 depicts the four pins of the USB port are connected to the four pins of the board mount header via a piece of PCB.

FIG. 8 depicts the placement of USB port below lower left corner of LCD display of an exemplary camera, the Panasonic DVX100/100A.

FIG. 9 depicts the FPGA/AUSB board affixed to the surface of CBA-4.

FIG. 10 depicts labeled wires surface mounted to the pins.

FIG. 11 is a flowchart diagram depicting the steps of building the Video Data Acquisition hardware into a digital video camera.

Corresponding reference characters indicate corresponding parts throughout the several views. Although the drawings represent embodiments of the present invention, the drawings are not necessarily to scale and certain features may be exaggerated in order to better illustrate and explain the present invention. The exemplification set out herein illustrates an embodiment of the invention, in one form, and such exemplifications are not to be construed as limiting the scope of the invention in any manner.

### DESCRIPTION OF THE EMBODIMENTS OF THE PRESENT INVENTION

The embodiment disclosed below is not intended to be exhaustive or limit the invention to the precise form disclosed in the following detailed description. Rather, the embodiment is chosen and described so that others skilled in the art may utilize its teachings.

In relation to video recording, this document uses some terms with specialized meanings. These terms are the means used by those skilled in the art of video recording and processing to most effectively convey the substance of their work to others skilled in the art.

“Charge Couple Device” or “CCD” is a light-sensitive computer chip in video cameras that acts as a sensor converting light into electrical flows. It is the digital camera equivalent of film.

“Digital Video” or “DV” is a video format launched in 1996, and, in its smaller tape form factor MiniDV, has since become one of the standards for consumer and semiprofessional video production.

“Field Programmable Gate Array” or “FPGA” is a type of integrated circuit that provides the ability to custom program and reprogram the component function.

“Programmable Read Only Memory” or “PROM” is a type of computer storage whose contents may be permanently fixed. It is permanent, or relatively permanent, program memory; programs and data are usually copied from PROM into a FPGA or RAM. Data in PROM is not lost when power is removed.

“Random Access Memory” or “RAM” is a type of computer storage whose contents may be accessed in any order. It is erasable program memory; programs and data are usually copied into RAM from a disk drive. Data in RAM is lost when power is removed.

“Synchronous Dynamic RAM” or “SDRAM” is a faster type of RAM because it may keep two sets of memory addresses open simultaneously. By transferring data alternately from one set of addresses, and then the other, SDRAM cuts down on the delays associated with non-synchronous RAM, which must close one address bank before opening the next.

“Universal Serial Bus” or “USB” is a protocol for transferring data to and from digital devices. Many digital cameras and memory card readers connect to the USB port on a computer.

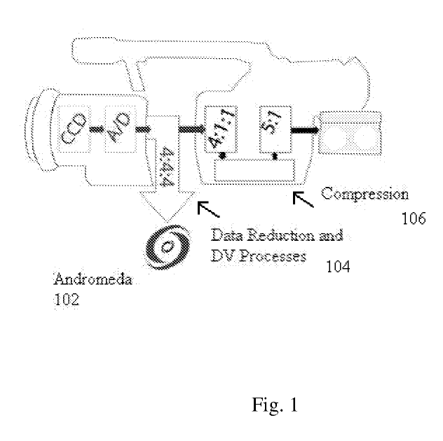

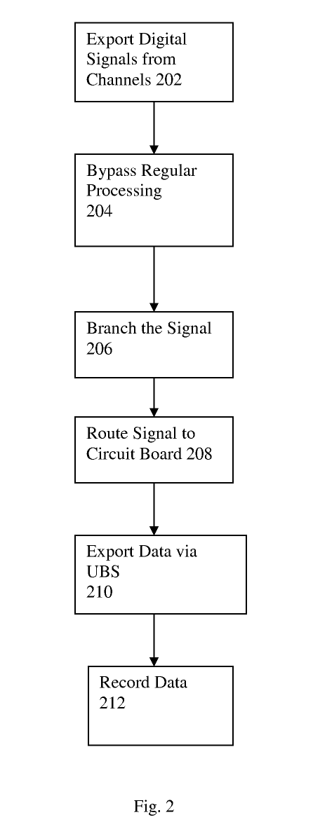

One embodiment of the present invention is depicted in FIG. 1. FIG. 1 is a systematic block diagram showing the location where the Video Data Acquisition (labeled Andromedia) is installed in a standard video recording camera. The function of the Video Digital Acquisition system is depicted in FIG. 2. The function is to extract the digital signals from all three (Red, Green, Blue) 12-bit color channels (step 202), plus the pixel clock, within a digital camera in a manner that allows this data to be routed to a USB bus. The process bypasses the regular processing (compression, decimation, etc) of the circuitry in such a camera (step 204). The system branches the signal from each channel downstream of the A/D converters (step 206), and routing it to a new circuit board (step 208). The camera retains all its native functionality, and thus data may be recorded (step 212) to the camera's original DV tape simultaneously with exportation of the data via USB (step 210).

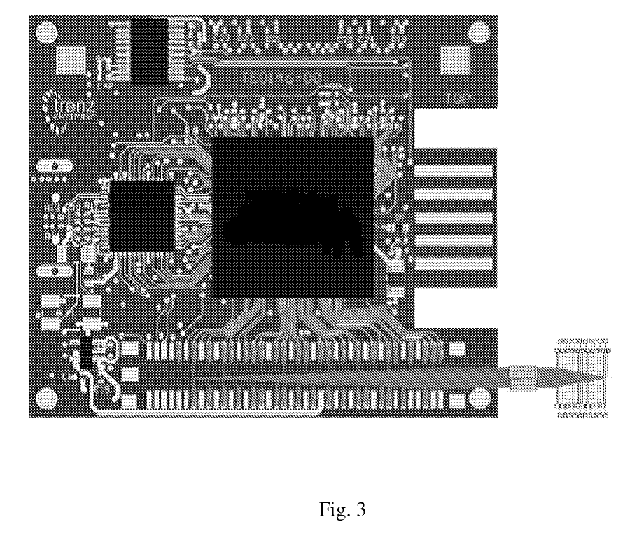

An exemplary electronic circuit board (FIG. 3) installed in such cameras has the following main components: an FPGA, the matching Flash PROM (for example a Xilinx XCF04S) from which the FPGA gets configured when powered on, SDRAM, and a USB 2.0 physical layer. The FPGA may be programmed using a combination of the standard hardware design techniques and methods. The FPGA of this embodiment may be programmed with a USB 2.0 Core allowing it to interface with the Physical Layer (“PHY”) interface to a USB2.0 Device Controller (for example, using a USB3250 quad flat no lead integrated circuit with a plurality of pins for connecting to the circuit board), which in turn interfaces the entire board to the USB Bus. The FPGA may also be programmed to interact with the SDRAM Memory, allowing it to store and retrieve data from the SDRAM chip. Finally, the digitized signals from the camera's internal Analog-To-Digital converters are fed directly to the FPGA. These signals contain the unaltered digital video initially captured by the camera of this embodiment. Other embodiments of electronic circuit boards are also contemplated by the present invention, including having an application specific integrated circuit (“ASIC”) having custom programming similar to the programming contained in the PROM of the exemplary embodiment.

Since this exemplary board is powered from the USB bus, the board is powered on when it is connected via USB to a computer. Shortly after power is applied, the FPGA configures itself from the programming saved in the Flash PROM, proceeds to initialize the SDRAM and USB2.0 Device Controller, and then goes into an idle state. When the operating system (i.e., the computer) on the other side of the USB bus requests video data, the FPGA begins by putting the video data as it comes into the SDRAM, and then reads it out of the SDRAM into the USB2.0 Device Controller which sends it over the USB cable to the computer using either BULK IN or ISOCHRONOUS IN USB transfer mode. The SDRAM may hold a significant amount of data, which is necessary because about half of the data coming in from the camera are dummy pixels and thus discarded. The buffering is used to evenly spread out the data so it may be sent over the limited bandwidth of USB 2.0, and also adds a level of robustness against glitches and temporary slow-downs of the USB bus.

To maximize performance, this exemplary board is configured as a USB device with only one USB endpoint. This prevents the bandwidth from being reduced since many systems pre-allocate bandwidth for each endpoint regardless of whether it is being used or not. The USB device has two possible configurations, with 1 IN endpoint each. The first possible USB configuration is used to configure the device depending on what video transfer settings the user selected from the software.

The second USB configuration is used to actually transfer video data. The configuration endpoint is selected by the software before video data is sent to the operating system. The operating system then uploads 3 lookup tables (LUTs) to the configuration endpoint that will map the original 12bit digital data from the Analog-To-Digital converters to 12-bit, 10-bit, or 8-bit data for each channel (R, G, B). Together with the LUTs, the software also sends the recording mode selected by the user. Depending on the users selection, the exemplary board will send different color

| A/D | | | | A/D |
|---|---|---|---|---|
| channel | Left | Pin | Right | channel |
| | MODE | 1 | TDO | |
| | V12 EN | 2 | TDI | |
| | DM | 3 | TCK | |
| | DP | 4 | TMS | |
| | VB+ | 5 | GND | G GND |
| | VB+ | 6 | LR6 | |
| R0 | LL7 | 7 | LR7 | G3 |
| | LL8 | 8 | LR8 | |
| R1 | LL9 | 9 | LR9 | G4 |
| | LL10 | 10 | PROG | |
| R GND | GND | 11 | LR11 | G5 |
| | LL12 | 12 | LR12 | G6 |
| R2 | LL13 | 13 | LR13 | |
| | LL14 | 14 | LR14 | G7 |
| R3 | LL15 | 15 | LR15 | G8 |
| R4 | LL16 | 16 | LR16 | G9 |
| | 3.3 V+ | 17 | GND | |
| R5 | LL18 | 18 | LR18 | G10 |
| R6 | LL19 | 19 | LR19 | G11 |
| | 3.3 V+ | 20 | LR20 | |
| R7 | LL21 | 21 | LR21 | B0 |
| | LL22 | 22 | LR22 | B1 |
| R8 | LL23 | 23 | GND | |
| | 1.8 V+ | 24 | LR24 | B2 |
| R9 | LL25 | 25 | LR25 | B3 |
| | LL26 | 26 | LR26 | |
| R10 | LL27 | 27 | LR27 | B4 |
| | 3.3 V+ | 28 | LR28 | |
| R11 | LL29 | 29 | LR29 | B5 |
| G0 | LL30 | 30 | 2.5 V | |
| | 3.3 V+ | 31 | LR31 | B6 |
| G1 | LL32 | 32 | LR32 | |
| G2 | LL33 | 33 | LR33 | B7 |
| | LL34 | 34 | LR34 | B8 |
| CLK GND | GND | 35 | LR35 | |
| | LL36 | 36 | GND | B GND |
| | LL37 | 37 | LR37 | |
| clock | LL38 | 38 | LR38 | B9 |
| | 1.2 V+ | 39 | LR39 | B10 |
| | 1.2 V+ | 40 | LR40 | B11 |

precisions (example 8bit, 10bit, etc) and different frame sizes. After configuration is complete, the software switches the device over to the second configuration and requests data. At this point the board starts sending video data over the USB using the user-selected options.

While this exemplary embodiment has been described in detail, any number of different interfaces may be used instead of a USB connection. Another example of an equivalent system is one that utilizes a different type of recording device such as a disk array or solid-state memory device instead of a computer. The hardware system will be different depending on what camera it is being applied to. However, the overall concept of extracting uncompressed image data from the camera, transmitting it over an interface to any type of recording and/or monitoring device is applicable to any digital video camera.

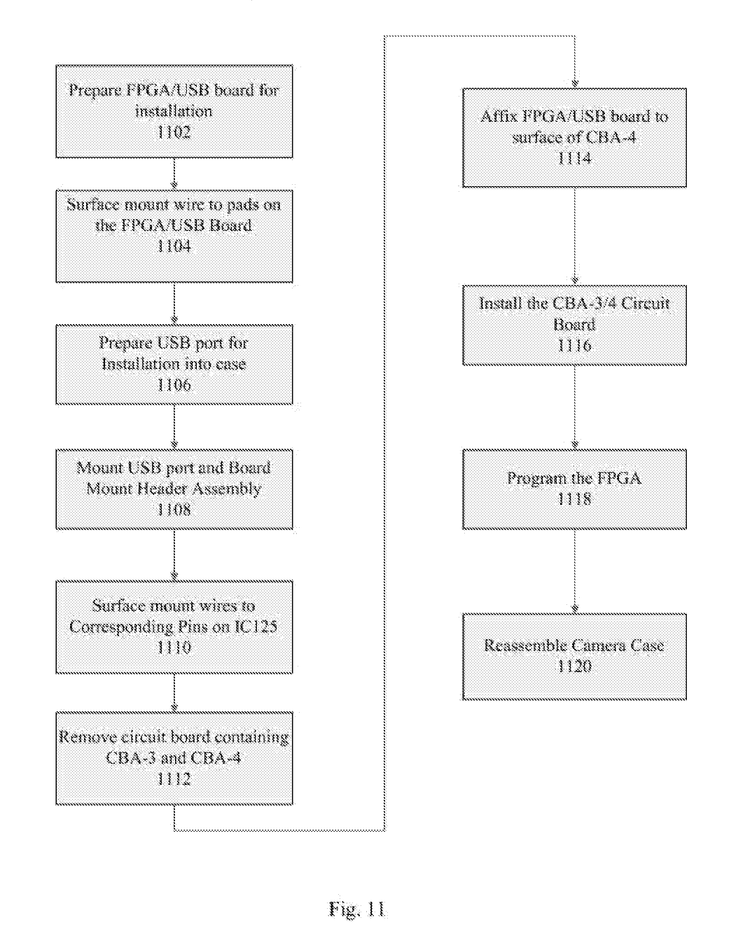

The process of building an exemplary system is depicted in FIGS. 3 through FIG. 11. The first step in building this exemplary system is to prepare the FPGA/AUSB board for installation (step 1102). As shown in table 1 below, 41 connections are made using 16 cm lengths of wire, preferably 34 AWG copper magnet wires. Each length of wire should be labeled at one end, according to the list of A/D channels and ground connections shown in the outer left and right columns of Table 1: R0-R11, G0-G11, B0-B11, R GND, G GND, B GND, CLK GND, and clock. Table 1 below depicts a Pinout table showing the order of surface mount connections to be made using labeled 16 cm lengths of 34 AWG magnet wire. “Pinout” is a term used in electronics to describe how a connector is wired. This pinout corresponds to the array of pads on the topside of the FPGA/AJSB board (see FIG, 1b). t,0100

Using the pinout key in Table 1, surface mount each labeled wire to its respective pad on the FPGA/USB board (step 1104). Use the array of pads on the side of the board containing the FPGA chip (the ‘top’ side). As wires are connected, they should be routed so that they all extend in a bundle next to the flash contacts. FIG. 3 depicts lengths of magnet wire surface mounted to FPGA pads (shown by arrow), shown along the bottom edge of the board in the above orientation. Wires should be bundled and routed toward right end of board as shown. In Table 1, ‘R0’ corresponds to the left end of the lower row of pads in this figure.

Next, a short set of wires is surface mounted to the pads for the USB connection. These pads are found on the opposite end of the board from the flash contacts, and on the same side as the SDRAM chip (the ‘bottom’ of the board). While any number of suitable wires may be used and will be known to those of skilled in the art, it is suggested that one skilled in the art use either multi-strand insulated wire of a gauge sufficient for the signal and power of a USB 2.0 connection, or simply cannibalize the wires from within a USB 2.0 cable. (The latter being the most convenient since the wires are already differentially colored and of slightly different gauge for power and ground versus signal.)

The 4 wires connecting the USB bus to the port in this embodiment should ultimately terminate in a disconnectable crimp style female receptacle housing with 2.5 mm pitch (for example, using a connector such as Dig key part #455-1002-ND). The wires should be cut to 5 cm in length and should each have one end terminated with a crimp contact for 22-30 AWG wire (e.g., Dig key part #455-1042-1-ND). It is recommended to actually solder the crimp contacts to the wire ends for a robust connection under stress because the wires will be twisted and then strained as the final connection to the USB port is made.

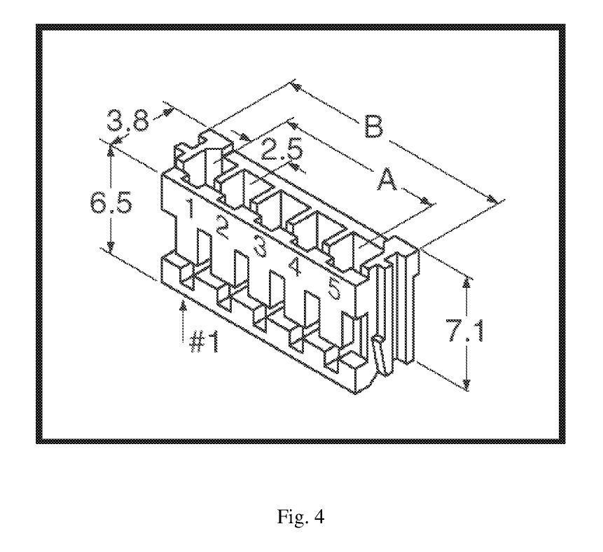

In this embodiment, to arrange the wires in correct order, the receptacle should be positioned as in FIG. 4 with the flexible tabs positioned away from the page. (While the figure depicts a 5-circuit receptacle it will be appreciated that 4-circuit receptacle should be used instead in this embodiment). FIG. 4 depicts a disconnectable crimp style female receptacle housing with 2.5 mm pitch. The order of insertion from left to right (1-4 in FIG. 2) should be ground (black), red (power), green (signal), white (signal).

Once the USB wires have been inserted into the crimp connector housing, they should be twisted and surface mounted to the USB pads on the FPGA/AJSB board. First twist together the signal wires (green and white). Next, wrap the ground and power wires around the signal wires, in opposite directions. To correctly order the connections to the pads, the circuit board should be held with the USB pads facing up and on the edge proximal to the installer.

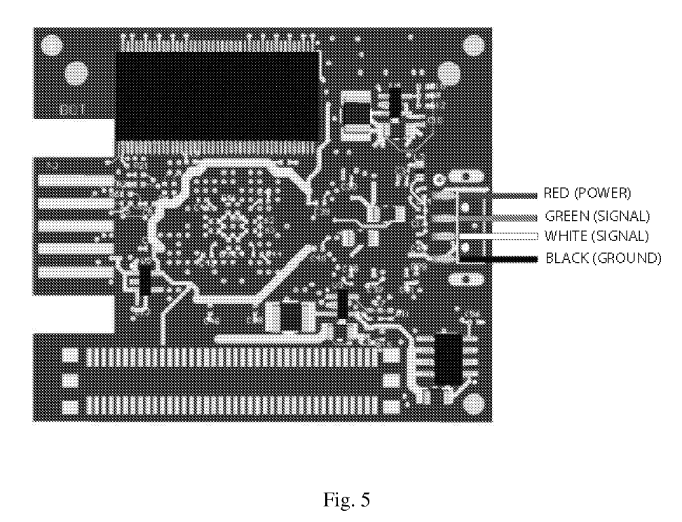

The order of surface mounts from left to right should be ground (black), signal (white), signal (green), and power (red). FIG. 5 depicts the bottom of an FPGA/USB board showing wires surface mounted to USB pads at right end of board. From bottom to top the order is ground (black), signal (white), signal (green), power (red). Both sides of the FPGA/AJSB board should be insulated (i.e., by covering with a layer of masking tape) when laid over CBA-3 in the camera (CBA-3 and CBA-4 are opposite sides of the circuit board that contains the three A/D converters.) If masking tape is used to insulate the board, it is advantageous to cut tape pieces in such a way that the flash contacts may easily be uncovered when the FPGA is programmed later.

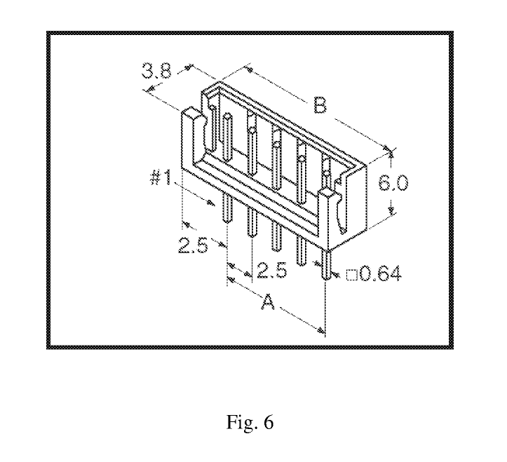

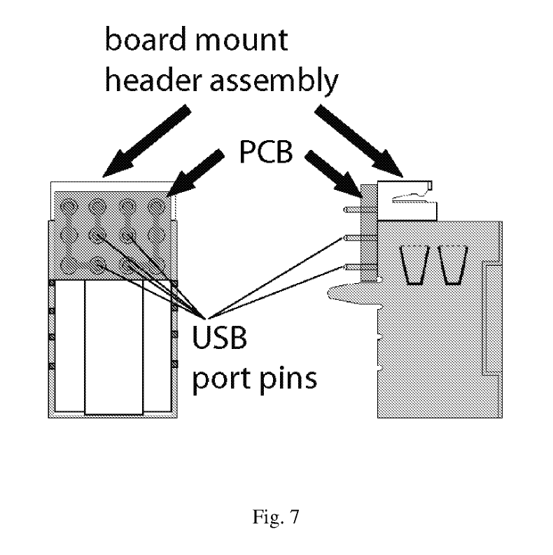

The next step of this exemplary method of installation involves preparing the USB port for installation into the camera case (step 1106). This requires three parts. First, a USB connector. For example, a B type, USB 4P, female, 90′R/A. (DigiKey part #AE1085-ND, Assmann Electronics part #AU-Y1007). The second part is a Top entry shrouded board-mount header. For example, a 2.5 mm pitch, 4 circuits. (Digikey part #455-1016-ND, J.S.T. part #B4B-EH-A). The third required part is a Cut piece of PCB with a 3×4 grid of holes, 2.5 mm pitch. FIG. 6 depicts a close-up view of the board mount header assembly. FIG. 7 depicts the four pins of the USB port are connected to the four pins of the board mount header via a piece of PCB. Traces of solder are made as shown in the left-most representation of the USB port, showing a view from the bottom. The diagram of the board mount header assembly, at top, is for a five-circuit version, but for this exemplary step of the modification a four-circuit version is used.

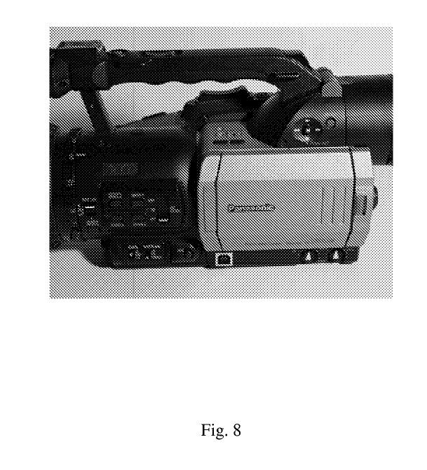

The USB port and board mount header assembly is now mounted in the side of the camera case (step 1108). This requires disassembling the camera enough to remove the side of the case that contains the LCD display. A square hole is cut, which exactly matches the shape of the USB port, just below the lower left corner of the LCD as viewed from the outside of the camera (See FIG. 8 for placement of the USB port). Port should be glued into place on the inner side of the camera case, with care taken not to foul the board mount header that receives the assembly of crimped USB wires. FIG. 8 depicts the placement of USB port below lower left corner of LCD display of an exemplary camera, the Panasonic DVX100/100A (manufactured by Matsusita Electric Industrial Co., Ltd. of Osaka. Japan). The port appears at bottom center of picture (identified by arrow).

Within the digital camera, each A/D converter produces 12 digital signals for its respective color, and all 36 signals are subsequently physically accessible as pins that surround the main processor chip (IC125 on CBA-3). The FPGA is connected to these signals (and digital ground connections) by surface mounting each of the labeled wires to corresponding pins on IC125 (step 1110). The clock signal and clock ground are taken from pins 15 and 16 on the red A/D converter (ICI on CBA-3).

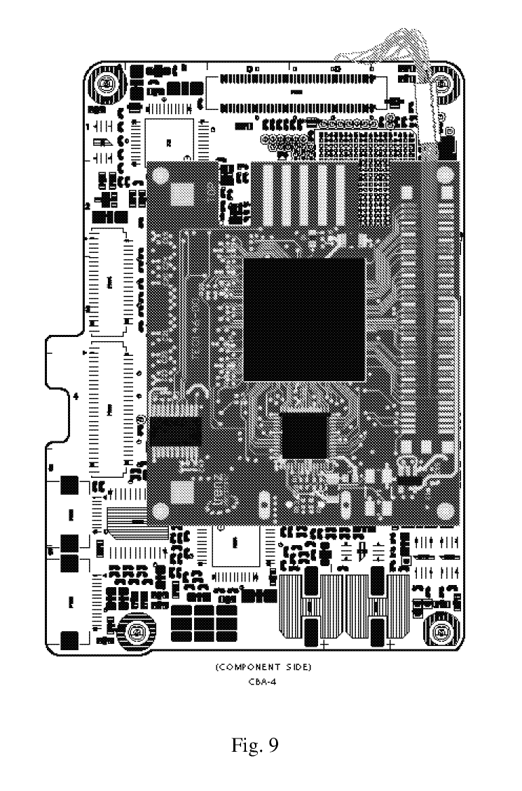

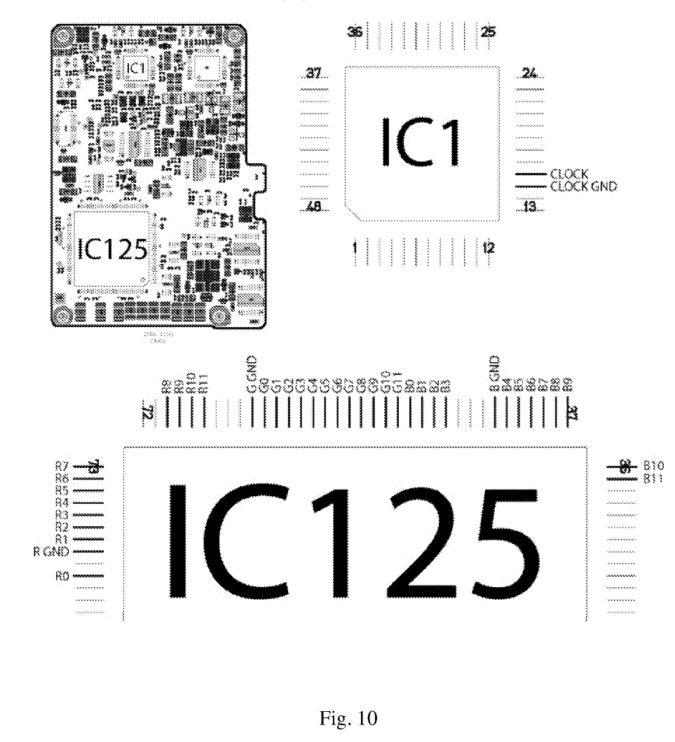

The circuit board containing CBA-3 and CBA-4 is removed (step 1112). The FPGA/AJSB board, prepared in Section 1, is affixed to the surface of CBA-4 (step 1114), as shown in FIG. 9 on page 14. The relative positioning in FIG. 9 is optimal and should be matched to allow re-assembly of the camera. The labeled wires should now be surface mounted to the pins indicated in FIG. 10. Double-sided sticky foam along the right side, between the two boards, is a sufficient attachment. Remember that, despite how the FPGA/AJSB board is shown in this figure, it should be covered with a layer of insulation (masking tape) on both sides at this point. Also, four wires carrying the signals, power, and ground connection for the USB port would extend from the bottom of the FPGA/AJSB board at this time.

FIG. 10 shows all digital signals and three digital ground connections are made on pins of IC125 (for example, an Altera FPGA) on CBA-3 of the digital camera (e.g., DVX1OOA). The clock signal and clock ground are taken from pins 15 and 16 of the (red) A/D converter (IC1). The next step of this exemplary method involves installing the assembly including the FPGA/AUSB board connected to the points of CBA-¾ from the camera back into the camera. The first step is to insert the crimp style female receptacle housing, in which the USB wires terminate, into the header assembly on the back of the USB port. The USB port should by now already be mounted in the side of the camera case as described above, and care should be taken that any adhesive on the port has completely set.

The next step is to install the CBA-¾ circuit board, replacing the four screws that hold it in place (step 1116). This will require some delicacy. The side of the case containing the USB port will have to be held close to the camera while this is done. While somewhat awkward, this should be done in order to keep the USB wires, between the port and the FPGA/AJSB board, as short as possible. The next step is to program the FPGA (step 1118), which in this embodiment requires a connection with both the USB port for power and the flash contacts for the FPGA for the actual programming data. Peel back the insulation (i.e., the masking tape) from the flash contacts on the FPGA/AUSB board enough to connect the cable from the FPGA programming device (e.g., the JTAG Programmer). Leave the side of the camera case, with the USB port, resting on top of the rest of the camera. After programming is completed, the camera case is reassembled and the installation of this embodiment of the Video Acquisition system is completed (step 1120).

The present invention also includes a software component. In the exemplary embodiment, the software is loaded from the PROM into the FPGA, which then implements the foregoing logic through a combination of program instructions for the FPGA and hardware specifications for the gates of the FPGA. The disclosed software is able to exploit the additional detail captured by taking into consideration the “Pixel Shift” when the files are processed, generating a higher resolution image. To explain how this is done, let's take a look at how digital video cameras that only have one imaging sensor (as opposed to 3, one for each basic color) work. Because standard imaging sensors are inherently monochromatic, it is usually not possible to record more than one color per sensor element. In order to obtain a color image from one sensor, a color filter array is employed such that each sensor element has a color filter in front of it.

A common filter array pattern is the Bayer pattern, in which a combination of Red, Green and Blue filters is used. This means that the raw output image of the sensor is a “mosaic” in which each pixel has only one of the three-color components. In order to generate a full-color image in which each pixel has all three-color components, a process commonly called “demosaicing” is carried out. There are many different algorithms known to those of skill in the art to do this, but the bottom line is that for any given pixel for which there is only one color component recorded, the information from the neighboring pixels is used to interpolate the missing color components. For example, for a Red pixel, the adjacent Green and Blue values may be used to approximate what the Green and Blue values for the Red pixel should be.

This is the same basic principle used in the software to take advantage of the “Pixel Shift” in order to obtain a higher resolution image. The software treats a multiple sensor-imaging block with “Pixel Shift” as a single color sensor of larger size. With prior knowledge of the shifted arrangement of the sensors provided by the user, the software builds a “mosaic” image, in which for each pixel there is incomplete color information. For example, lets suppose that in a particular camera, the Red-imaging sensor is shifted horizontally by half a sensor element width relative to the Green sensor. This means that each element in the Red sensor records optical image details that lie in between the elements of the Green sensor, and vice versa. This also means that, disregarding limitations of the lens, the Red sensor records optical details that the Green sensor does not capture, and vice versa. Thus, disregarding the Blue sensor, a line of the “mosaic” image generated by the software could read: RGRGRGRG, etc. Where each ‘R’ or ‘G’ represents one pixel on the line, and ‘R’ represents a pixel for which we only have Red information and ‘G’ a pixel for which we have Green information.

Until now, it appears that no method has been developed to properly “demosaic” this type of image. However, there are plenty of papers on different ways to “demosaic” the Bayer pattern and other patterns that are obtained from single color sensors. The main difference between the mosaic images obtained from a “Pixel Shift” multiple sensor block and a color single sensor, is the pattern in which the partial color data is recorded. Taking this into consideration, we have adapted several methods described in research papers for single color sensors, to work with multiple-sensor “Pixel Shift” arrays. The resulting images are larger in pixel count and have a higher resolution than the images normally obtained by the camera.

In one embodiment, the present invention makes use of adaptations of several demosaicing algorithms originally devised to work with Bayer pattern sensors by utilizing the similarities between the Bayer pattern and the mosaic obtained from a shifted multiple sensor array. The Bayer pattern is shown in the table below:

| | |
|---|---|
| [0058] Green | [0059] Red |
| [0060] Blue | [0061] Green |

Each cell in the table is a pixel, and the contained color is the available color component for that pixel in the Bayer mosaic. This pattern, repeated over an image depicts the available color data in an image sampled from a traditional color-imaging sensor. There are many ways in which a shifted multiple sensor array may be configured, but lets take as an example a 3-sensor array where each sensor records a single basic color, either Red, Green or Blue. Let's also assume that the Red and Blue sensors are aligned respective to each other, but they are both shifted diagonally by half a pixel from the Green. The resulting mosaic pattern would look like this:

| | |
|---|---|
| [0063] Green | [0064] |
| [0065] | [0066] Red, Blue |

The empty cells (pixels) in this pattern mean that there is no information for that location. Taking a look at these two patterns, we see that a horizontal line of the Bayer pattern (either GRGRGR . . . or GBGBGB . . . ) looks identical to a diagonal line of the shifted color sensor array example given. This is an example of one of the similarities we used to adapt existing Bayer algorithms to a shifted sensor setup. Taking into consideration this information, we created modified versions of the algorithms described in the papers:
Ron Kimmel, “Demosaicing: Image Reconstruction from Color CCD Samples,” IEEE Transactions on Image Processing, Vol. 8, No. 9, pp 1221-1228, September 1999.
X. Li, M. T. Orchard, “New Edge-Directed Interpolation,” IEEE Transactions on Image Processing, Vol. 10, No. 10, October 2001.
K. Hirakawa and T. W. Parks, “Adaptive homogeneity-directed demosaicing algorithm,” in Proc. IEEE Int. Conf. Image Processing, vol. 3, pp. 669-672, September 2003.

The embodiments of the present invention makes use of new algorithms generated based on methods described in other papers as well, but the methods from the listed papers yield the best results up to date. All the algorithms described in these papers take a Bayer mosaic as an input. Using similarities as the one described above, variations of these algorithms have been generated to work with shifted sensor arrays.

The embodiments of the present invention utilizes these developed algorithms to “demosaic” the raw sensor data recorded from the camera into a larger frame size than what each individual sensor may support. For example, on a camera with the shifted sensor array yielding the pattern in the table above, the developed algorithms may yield an image four times the pixel size of each individual sensor. If as an example each sensor is 770×492 pixels in size, then the developed algorithms may yield an image 1540×984.

Another embodiment of the present invention relates to the user interface of the software component needed to render the raw data files. Exemplary software may reside in computer operating systems, hard disk arrays, or other like devices. Such software may be used to control recording and video file rendering. To properly use the software, preferences should be set before any serious recording is performed, especially for the Capture Path, Render Path, and Channel Shift.

The exemplary software includes a ‘Capture Path’ dialog box that allows a user to specify the directory, or folder, into which the software places raw files as they are recorded. It is recommended that the user first create an empty folder that he/she wishes to use for raw files. The user may then use the ‘Browse’ button next to the ‘Capture Path’ dialog box to browse to the location of your folder.

The exemplary software includes a ‘Render Path’ dialog box that allows the user to specify the directory, or folder, into which he/she wishes the software to place processed files (either rendered frames or movie clips). Remember that the raw file remains intact in its original location (the folder specified in the Capture Path). When a raw file is processed to produce either rendered frames or movie clips, these processed versions of the raw file will be stored in the location designated by the Render Path. As above, it is recommended that the user first create an empty folder that he/she wishes to use for processed files. The user may then use the ‘Browse’button next to the ‘Render Path’ dialog box to browse to the location of the folder.

The exemplary digital camera, the Panasonic DVX100/100A/100B, described above uses a fractional pixel shift among the CCDs. For rendering purposes, the software must know by how much the red, green, and blue fields have been shifted so that demosaicing may be correctly executed. The software contains default settings for these digital cameras; however, it has been found that these values must sometimes be experimentally adjusted for individual cameras.

The steps the software performs are as follows: 1) Record a short raw file and render a frame. It is best to have an image that is well lit and containing objects near the center of the image that have clearly visible edges. 2) Inspect the center of the image for casting. ‘Casting’ is a phenomenon in which edges reveal that at least one of the three-color fields is misaligned. An edge may appear to be lined with a very thin border of color. For instance, if an edge appears to have a yellow cast, this indicates that the blue field is misaligned. Along the brightest part of this edge, only red and green pixels are properly positioned, causing yellow to appear, with blue being absent at pixel positions where it ought to be. Note that casting may also appear as a result of chromatic aberrations that are produced by the camera lens. This type of casting should not appear in the center of the image, however, and this is why the edges in the center of the image should be used to detect casting that has a digital origin. 3) The correct channel shift values may now be empirically determined by changing the values, then re-rendering the same frame. Continue until casting has been eliminated. Once this process is completed for an individual camera, these values should not have to be changed.

It is only during the process of rendering that channel shift misalignment causes casting, as a result of incorrect demosaicing. The raw file originating from the Video Data Acquisition system is not affected by problems with channel shifting; consequently, it is not necessary to re-record anything that appears to have casting once rendering is completed. Simply adjust the Channel Shift values correctly to match the camera, and re-render anything that did not appear to be correctly demosaiced the first time. The software renders/demosaices as described above and below.

When this exemplary software is started up, the user will have the option from selecting between three windows: Record, Input Batch, and Render Output. In the ‘Record’ window, a user selects a Mode from a pull down menu to record in and then selects a Look-Up Table for recording from another pull-down menu (“Record LUT”) BEFORE the camera is selected. The software allows the user to add its own LUTs to this drop down menu.

After a capture path, mode and record LUT have been chosen, the camera is connected to the computer by choosing the specific camera that is connected to the USB 2.0 port within the Record window. In the ‘Record’ window, the user may select his/her camera by clicking the pull-down menu labeled ‘Select host camera to start’ and highlighting the camera. It should appear as the only recognized USB device within that pull-down menu. At this point a preview window will appear containing a monitor that displays real-time output from the camera via the Video Data Acquisition system. The system is not recording at this point. Rather, the recording Start and Stop functions are controlled by the user within the Preview window. The software may be instructed to automatically detect and connect to the camera once the USB connection is made between the camera and computer.

In the exemplary software, rendering frames or movie clips is done using both the Input Batch and Render Output windows. Adding multiple files in the Input Batch window allows a user to process multiple files at once. To choose files for processing, the user may click the ‘Add’ button in the Input Batch window. A window for searching directories will appear. The user may browse to the location of a desired file, highlight it, and click ‘Open’ and may repeat this process for each file that the user wishes to have in a batch.

If the user decides that a particular file should not be in a batch, the user may remove it by highlighting the file within the Input Batch window and clicking ‘Remove’ or the user may select ‘Delete’ to remove it from the Batch and permanently delete it from a capture directory.

Before a batch (or single file) is processed, the user may choose whether he/she desires to render the captures into ‘Individual Frames’ or ‘Movie Clips’ by clicking the appropriate button at the top of the Render Output window. By using the proper drop down menus, the user may also choose the desired Render LUT, Gamma curve, Frame size, and Codec within the Render Output window. Once all these settings have been chosen within the Render Output window, the user clicks ‘Process’. All files listed in the Input Batch window will be rendered, as described above, in according to the selected settings, and the rendered files will appear in the folder designated in the Render Path set in Preferences. As additional functionality, the user maybe given the option to turn on sound that will notify the user when recording has successfully started and stopped or the preview monitor may have a feature turned on that allows the user to highlight areas of clipping.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

We claim:

1. A circuit board for use with a digital camera having monitoring sensors, said circuit board comprising:
a. interface circuitry adapted to obtain raw video data from the monitoring sensors of the camera;
b. processing circuitry adapted to convert signals from said interface into a digital format for storage; and
c. an output adapted to transmit video data in the digital format to a monitoring device.

2. The digital video processing system of claim 1 wherein said processing circuitry is adapted to demosaic the raw video data.

3. The circuit board of claim 1 wherein said processing circuitry is adapted to calculate pixel shift adjustments to the raw video data.

4. The circuit board of claim 1 wherein said processing circuitry is adapted to render the raw video data.

5. The circuit board of claim 1 further comprising a Universal Serial Bus port.

6. The circuit board of claim 5 wherein said output is adapted to transmit video data in the digital format to the monitoring device via the Universal Serial Bus port.

7. The circuit board of claim 1 further comprising a memory storage device.

8. The circuit board of claim 1 wherein said processing circuitry is adapted to be programmed by software operating on the monitoring device.

9. A method for processing uncompressed digital video data from a digital video camera comprising the steps of:
a. obtaining uncompressed digital video data from sensors of a video digital camera as input;
b. processing the uncompressed input into a digital video format; and
c. transmitting data in the digital video format to a monitoring device.

10. The method of claim 11 wherein the monitoring device is adapted to record digital video data.

11. The method of claim 11 wherein the step of transmitting digital video data to the monitoring device is done via Universal Serial Bus.

12. The method of claim 11 further including the step of interfacing with a memory storage device.

13. The method of claim 11 further including the step of interfacing with the monitoring device to accept user input selections.

14. The method of claim 11 wherein the step of transmitting digital video data to the monitoring device is done based on user input selections.

15. The method of building a digital video processing system into a digital video camera including:
a. opening digital video camera case;
b. installing electronic circuit board into said digital video camera case;
c. programming the electronic circuit board; and
d. reassembling digital video camera case.

16. The method of claim 17, further including the step of installing Universal Serial Bus circuitry.
